(19) United States
(12) Patent Application Publication
(10) Pub. No.: US 2026/0291314 A1
(43) Pub. Date: Sep. 24, 2026

(54) ELECTRIC ROTATING MACHINE

(71) Applicant: Mitsubishi Electric Mobility Corporation, Tokyo (JP)

(72) Inventors: Shoya MIZOKAMI, Tokyo (JP); Motoaki KIMURA, Tokyo (JP)

(73) Assignee: Mitsubishi Electric Mobility Corporation, Tokyo (JP)

(21) Appl. No.: 19/474,487

(22) PCT Filed: Jun. 12, 2023
(86) PCT No.: PCT/JP2023/021731

§ 371 Date: Oct. 10, 2025

(51) Int. Cl. H02K 1/32; H02K 1/278

(52) U.S. Cl. CPC H02K 1/32; H02K 1/278

(57) ABSTRACT

The electric rotating machine includes a rotor and a stator disposed around an outer circumference of the rotor, the rotor being provided with: a rotating shaft having an axial passage and radial passages; a rotor core fixed to the rotating shaft and having permanent magnets and axial cooling passages for cooling the permanent magnets; and an end plate that is fixed to one axial end of the rotor core and that constitutes, together with the end of the rotor core, a first reservoir portion connected to the radial passages of the rotating shaft, a second reservoir portion connected to the cooling passages of the rotor core, and orifices that connect together the first reservoir portion and the second reservoir portion.

### TECHNICAL FIELD

The present application relates to an electric rotating machine.

### BACKGROUND ART

An electric rotating machine is configured with a rotor fixed to a rotating shaft, a stator disposed around the outer circumference of the rotor, a housing for protecting them, and so on. Here, in particular, a cooling structure of an electric rotating machine having a rotor provided with permanent magnets fixed thereto will be described.

According to the electric rotating machine having a rotor provided with permanent magnets fixed thereto, heat will be generated because of a current flowing in a coil wound on the stator. When a flow of field current in the coil is established or interrupted, a magnetic field is generated or disappears, so that a magnetic flux through the stator core and the rotor core is generated or disappears. Because of the generation and disappearance of the magnetic flux, eddy currents flow in these cores, so that the cores generate heat. Further, a field magnetic flux due to the permanent magnet of the rotor and an armature magnetic flux due to the current of the coil interfere with each other, so that the permanent magnet generates heat. When the permanent magnet is overheated to exceed a specified temperature, demagnetization occurs, so that the performance of the electric rotating machine is degraded. Accordingly, there arises a need to drive the electric rotating machine while cooling the permanent magnets.

With respect to the rotor of the electric rotating machine that is provided with permanent magnets fixed thereto, there is a technique of cooling these permanent magnets. There is disclosed such an electric rotating machine in which, in order to cool the permanent magnets, plural cooling passages for flowing a coolant in the axial direction of the rotor are formed. As the cooling passages for flowing the coolant that are formed in the core of the rotor, reluctance holes are used that are formed correspondingly to the magnetic poles of the rotor. In the rotating shaft of the rotor, an axial passage and radial passages connected to the axial passage are formed. To the radial passages that are each formed per each of the cooling passages for flowing the coolant, the coolant is supplied from the axial passage. From the radial passages that are formed in an axial center portion of the rotating shaft, the coolant is brought to the radially outer side through passages formed in the magnetic plates of the rotor core, so that the coolant is supplied into the reluctance holes that are formed along the axial direction. The coolant flows using the reluctance holes as cooling passages, so that the permanent magnets are cooled (for example, Patent Document 1).

### CITATION LIST

### Patent Document

Patent Document 1: Japanese Patent Application Laid-open No. 2013-27100

### SUMMARY OF INVENTION

### Technical Problem

According to the rotor of the electric rotating machine disclosed in Patent Document 1, it is required to form the radial passage in the rotating shaft, per every cooling passage for flowing the coolant that is plurally formed along the axial direction in the rotor core. Precision processing is required for forming the radial passage in the rotating shaft. Thus, as the number of the radial passages increases, the number of processing steps becomes larger, resulting in an increase in cost. Meanwhile, in order to uniformly cool the individual permanent magnets, it is required that the coolant flow rates of the respective radial passages be evenly set. For that purpose, the radial passages have to be processed more precisely and this results in a further increase in cost. In addition, since the axial passage of the rotating shaft has to be formed so that it extends to the axial center portion of the rotating shaft, the length of the axial passage is increased. This may cause an increase in the number of processing steps and a decrease in the strength of the rotating shaft.

An electric rotating machine according to the present application is intended to uniformize the distribution of the coolant toward the cooling passages that are formed along the axial direction in the rotor core, while decreasing the number of the radial passages in the rotating shaft to thereby reduce the number of processing steps. It is further intended to reduce the length of the axial passage to be formed in the rotating shaft, to thereby prevent both an increase in the number of processing steps and a decrease in the strength of the rotating shaft.

### Solution to Problem

An electric rotating machine according to this application comprises a rotor and a stator disposed around an outer circumference of the rotor,
said rotor being provided with:
a rotating shaft having an axial passage and at least one radial passage connected to the axial passage;
a rotor core fixed to the rotating shaft and having permanent magnets and axial cooling passages for cooling the permanent magnets; and
an end plate that is fixed to one axial end of the rotor core and that constitutes, together with said end of the rotor core, a first reservoir portion connected to said at least one radial passage of the rotating shaft, a second reservoir portion connected to said cooling passages of the rotor core, and orifices that connect together the first reservoir portion and the second reservoir portion.

### Advantageous Effects of Invention

In accordance with the electric rotating machine according to this application, it becomes possible to uniformize the distribution of the coolant toward the cooling passages: formed along the axial direction in the rotor core, while decreasing the number of the radial passages in the rotating shaft to thereby reduce the number of processing steps. Further, it becomes possible to reduce the length of the axial passage to be formed in the rotating shaft, to thereby prevent both an increase in the number of processing steps and a decrease in the strength of the rotating shaft. Accordingly, an electric rotating machine that is capable of effectively cooling the permanent magnets provided in the rotor can be achieved with a smaller number of the steps and at low cost.

### BRIEF DESCRIPTION OF DRAWINGS

FIG. 1 is a sectional view showing a configuration of an electric rotating machine according to Embodiment 1.

FIG. 2 is a sectional view showing a rotor of the electric rotating machine according to Embodiment 1.

FIG. 3 is a sectional view showing coolant passages formed in an end plate of the electric rotating machine according to Embodiment 1.

FIG. 4 is a sectional view showing radial passages formed in a rotating shaft of the electric rotating machine according to Embodiment 1.

FIG. 5 is a sectional view showing coolant passages formed in an end plate of an electric rotating machine according to Embodiment 2.

### DESCRIPTION OF EMBODIMENTS

### 1. Embodiment 1

### <Configuration of Electric Rotating Machine>

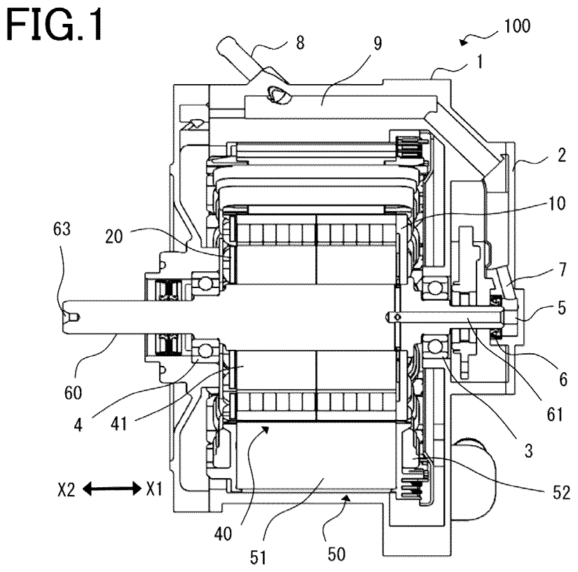

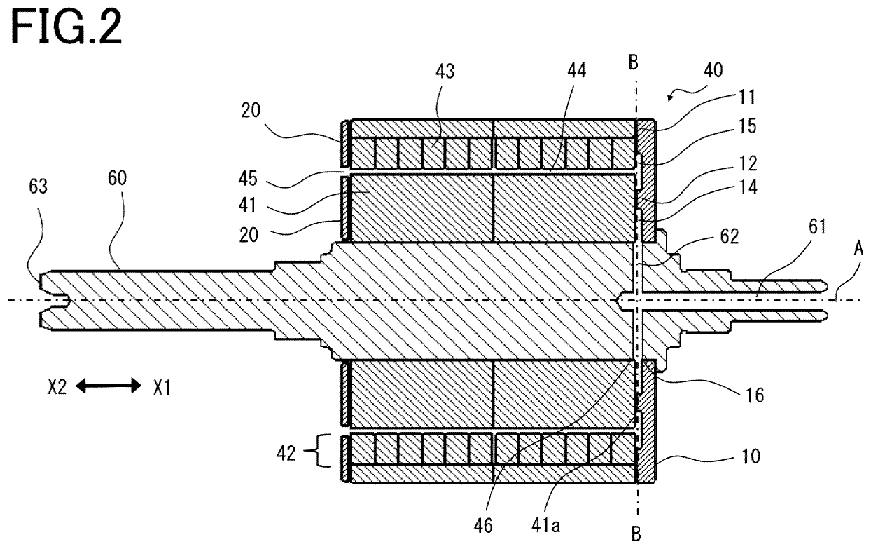

In the following, an electric rotating machine 100 according to Embodiment 1 of this application will be described with reference to drawings. FIG. 1 is a sectional view showing a configuration of the electric rotating machine 100 according to Embodiment 1. In FIG. 1, hatching indicative of a cross section is omitted because it complicates that figure. FIG. 2 is a sectional view showing a rotor 40 of an electric rotating machine 100 according to Embodiment 2. In FIG. 2, only cross sections of structural objects taken by cutting them are described. Both of FIG. 1 and FIG. 2 show cross sections cut along a plane passing through the axis of a rotating shaft 60.

An electric rotating machine is a generic term of an electric motor, an electric power generator, an electric motor-generator, and the like. As shown in FIG. 1, the electric rotating machine 100 includes a housing 1 and a stator 50 disposed in the housing 1. The stator 50 is integrated with the housing 1 to rotatably support the rotating shaft 60 of the rotor 40 by way of a bearing 3 and a bearing 4. The stator 50 includes an annular stator core 51 and a stator winding 52 wound on the stator core 51, and is disposed around the outer circumference of the rotor.

### <Rotor Core>

The rotor core 40 includes the rotating shaft 60 and a rotor core 41 fixed to the rotating shaft 60. The rotating shaft 60 has an output portion 63 and, with respect to FIG. 1 and FIG. 2, a side of the rotating shaft where the output portion is placed is defined as an “axial direction second side X2” and a side opposite to the output portion is defined as an “axial direction first side X1”. The rotor core 41 of the rotor 40 is constituted in such a manner that magnetic steel sheets are stacked in the axial direction, and is fixed to the rotating shaft 60 by press fitting, welding or the like.

As shown in FIG. 2, in the rotor core 41, a plurality of magnet storage holes 42 are created in parallel to the axial direction. Permanent magnets 43 are stored in the magnet storage holes 42 and fixed therein using an adhesive or the like. The rotor 40 is constituted as a permanent magnet embedded rotor, namely, a so-called IPM (Interior Permanent Magnet) type rotor. The magnet storage holes 42 do not only store the permanent magnets 43 but also have their respective spaces through which a coolant passes, so that cooling passages 44 are ensured. As a coolant for cooling the permanent magnets 43, although an oil-based coolant or a water-based coolant may be used, a cooling oil is often used. A lubricant oil may be commonly used as a cooling oil.

The magnet storage holes 42 are each created in an outer circumferential portion of the rotor core 41 so as to extend from its one axial end to the other end and in parallel to the rotating shaft 60, and are arranged along a circumferential direction plurally at an equiangular pitch. The magnet storage holes 42 whose number is the same as, or an integral multiple of, the number of magnetic poles of the rotor 40, are created. There are cases where a single permanent magnet 43 is provided per each of the magnetic poles and cases where a plurality of permanent magnets 43 are provided per each of the magnetic poles.

The rotor core 41 is formed in such a manner that annular plate members as magnetic steel sheets are stacked in the axial direction. As the material of these plate members, a magnetic material such as iron, permalloy, an amorphous magnetic alloy or the like, is used. Using the inner circumferential surface of the rotor core 41, a center hole is formed into which the rotating shaft 60 is to be press fitted.

An end plate 10 is fixed to an end portion of the rotor core 41 on the axial direction first side X1, and a fixing end plate 20 is fixed to an end portion thereof on the axial direction second side X2. The end plate 10 and the fixing end plate 20 are attached and fixed from both axial sides the rotating shaft 60 by press fitting, welding, screw fastening or the like. It is further noted that the end plate 10 and the fixing end plate 20 prevent the rotor core 41 from being detached from the rotating shaft 60. The end plate 10 is fabricated to have an outer diameter that is enough to cover the magnet storage holes 42 but is smaller than the diameter of the rotor core 41. Since the end plate 10 rotates with the rotor, its dimensions are determined so that it does not contact the stator 50.

Although the fixing end plate 20 may have an outer diameter that is the same as that of the end plate 10, it may be fabricated to have a small diameter so that the fixing end plate occupies a place that is radially inner side of the place of the magnet storage holes 42. In FIG. 1 and FIG. 2, a case is shown where the fixing end plate 20 and the end plate 10 are fabricated to have a same outer shape. In the fixing end plate 20, coolant outlets 45 are formed. The coolant is allowed to go out of the cooling passage 44 that is additionally provided in the magnet storage hole 42, toward the axial direction second side X2 through the coolant outlet 45. When the rotor core 41 is fixed to the rotating shaft 60 tightly by press fitting or the like, the fixing end plate 20 may be omitted.

### <Coolant Passage in Rotating Shaft>

In the rotating shaft 60, an axial passage 61 as a coolant passage is formed at the shaft axis position of the rotating shaft. The axial passage 61 is formed from one end on the axial direction first side X1 along a shaft center line A up to the attachment position of the end plate 10.

At the attachment position of the end plate 10 to the rotating shaft 60, radial passages 62 connected to the axial passage 61 are formed. The radial passages 62 are formed radially outwardly from the axial passage 61 so as to open on the outer circumferential surface of the rotating shaft. Note that the axial passage 61 may be formed along the shaft center line A from the one end on the axial direction first side X1 to extend beyond the attachment position of the end plate 10.

### <Coolant Passages in End Plate>

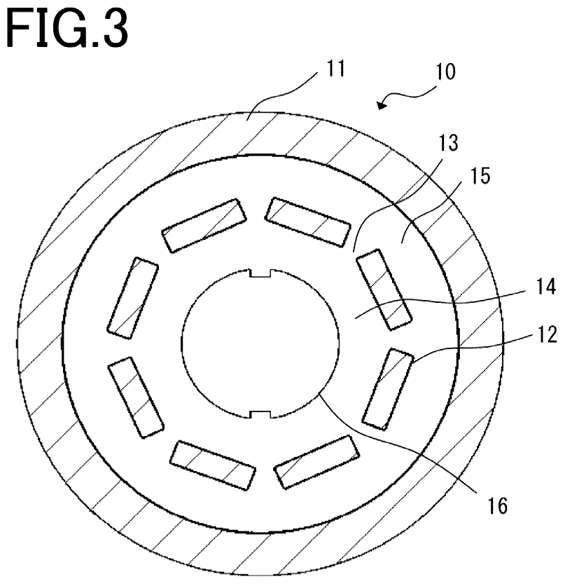

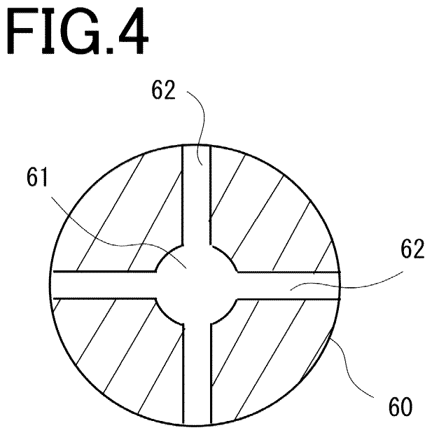

FIG. 3 is a sectional view showing coolant passages formed in the end plate 10 of the electric rotating machine 100 according to Embodiment 1. FIG. 3 is a sectional view of the end plate 10 after being cut along a cut plane B-B in FIG. 2, viewed in the direction toward the axial direction first side X1 from a side where the rotor core 41 is placed. FIG. 4 is a sectional view showing the radial passages 62 and the axial passage 61 formed in the rotating shaft 60 of the electric rotating machine 100 according to Embodiment 1. FIG. 4 is a sectional view of the rotating shaft 60 after being cut along the cut plane B-B in FIG. 2, viewed in the direction toward the axial direction second side X2 from a side where the end plate 10 is placed. In FIG. 4, four radial passages 62, each being branched from the axial passage 61 and extending radially outwardly, are arranged along a circumferential direction at an equiangular pitch.

As shown in FIG. 3, the end plate 10 is fixed to a rotor-core end portion 41a of the rotor core 41 from the direction toward the axial direction second side X2. Further, by the end plate 10 and the rotor-core end portion 41a, a first reservoir portion 14 (which may be referred to as a first coolant pool) and a second reservoir portion 15 (which may be referred to as a second coolant pool) are formed. In addition, orifices 13 that connect together the first reservoir portion 14 and the second reservoir portion 15 are formed therebetween. Further, the periphery of the second reservoir portion 15 is enclosed by an outer peripheral wall 11.

The first reservoir portion 14 and the second reservoir portion 15 are formed in such a manner that the surface of the end plate 10 facing to the rotor-core end portion 41a is recessed annularly. The radial passages 62 formed in the rotating shaft 60 are connected to the first reservoir portion 14, so that the coolant is supplied thereto from the radial passages 62. The cooling passages 44 formed in the rotor core 41 are connected to the second reservoir portion 15, to thereby receive coolant supply from the second reservoir portion 15. The flow rate of the coolant flowing from the first reservoir portion 14 to the second reservoir portion 15 is restricted by the cross-section areas of the orifices 13.

Shield walls 12 that separate the first reservoir portion 14 and the second reservoir portion 15 from each other are formed in such a manner that wall-shaped convex portions are created partially in the recessed portion of the end plate 10. The end plate 10 provided with the shield walls 12 may be composed of a casting material. In that case, in the end plate 10, recessed portions that establish spaces for the first reservoir portion 14 and the second reservoir portion 15, the shield walls 12 formed of the wall-shaped convex portions, and the outer peripheral wall 11 that encloses the periphery, are integrally shaped using a casting mold. Accordingly, the end plate 10 is composed as a one-piece seamless metallic member.

### <Cooling Passages in Rotor Core>

As shown in FIG. 2, the cooling passages 44 in the magnet storage holes 42 created in the rotor core 41 each open into the second reservoir portion 15. As the result, the cooling passages 44 can receive coolant supply from the second reservoir portion 15. The cooling passages 44 may be formed independently of the magnet storage holes 42. The cooling passages 44 are formed as penetration holes provided near the respective permanent magnets and axially penetrating through the stacked steel plates of the rotor. The cooling passages 44 just have to be able to cool the permanent magnets.

It is efficient if the cooling passage 44 is configured as a part of the magnet storage hole 42, because the coolant can directly cool the permanent magnets 43. However, there may be cases where the cooling passage 44 hinders the permanent magnet 43 from being fixed in the magnet storage hole 42. Thus, an independent penetration hole that is axially juxtaposed to the magnet storage hole 42 in the vicinity thereof may be used as the cooling passage 44. Even in either configuration, the cooling passage 44 just has to be capable of intended heat exchange between the permanent magnets 43 and the coolant flowing in the cooling passage 44. It is all right if the cooling passage 44 is placed in the vicinity of the permanent magnets 43 and the mutual distance of them is in a range where the cooling of the permanent magnets 43 is not hindered.

### <Cross-Section Area of Coolant Passage>

Here, the passage cross-section areas of the axial passage 61 and the radial passages 62 formed in the rotating shaft 60 will be discussed. Further, the passage cross-section areas of the orifices formed between the first reservoir portion 14 and the second reservoir portion 15 that are constituted between the end plate 10 and the rotor-core end portion 41a, will be discussed. Flow paths between the first reservoir portion 14 and the second reservoir portion 15 is narrowed down by the orifices 13 formed by the shield walls 12.

The cross-section area of the axial passage 61 formed in the rotor shaft 60 is defined as “S1”, the cross-section area of the radial passage 62 is defined as “S2” and the cross-section area of the orifice 13 is defined as “S3”. In that case, if the respective sums of cross-section areas of the respective types of passages are represented by “ΣS1”, “ΣS2” and “ΣS3”, the following relationship is preferable.

$$Σ S 1 > Σ S 2 > Σ S 3$$

Focusing on the case described in FIG. 1 to FIG. 4, there are provided a single axial passage 61, four radial passages 62 and eight orifices 13. Thus, the following relationship is preferable.

$$S 1 > ( S 2 \times 4 ) > ( S 3 \times 8 )$$

With respect to the coolant passages, the sum of passage cross-section areas is reduced as the flow goes downstream. This makes it possible to stabilize the coolant flow rate in the cooling passage 44 on the most downstream side. Even in the case where the amount of the coolant supplied to the axial passage 61 is relatively small, a flow path space that is just before the respective positions where the passage cross-section areas are reduced, can be filled with the coolant to thereby temporarily store that coolant. As a result, it becomes possible to supply the coolant uniformly with respect to the respective magnetic poles of the rotor core 41.

As shown in FIG. 1, the electric rotating machine 100 is provided with a coolant inlet port 8 on the upper side of the housing 1. The coolant flows in through the coolant inlet port 8 and then flows to a coolant delivery portion 9. The coolant having flowed in the coolant delivery portion 9 is discharged through an opening to the inside of the housing 1. An end portion of the housing 1 on the axial direction first side X1 is provided with a cover 2. A rotating-shaft-front coolant reservoir portion 5 is formed in a state enclosed by the cover 2 and a sealing 6. A guide member 7 is disposed on the rotating-shaft-front coolant reservoir portion 5 placed between the cover 2 and the inlet of the axial passage 61 in the rotating shaft 60. The coolant supplied through the guide member 7 is sent into the axial passage 61 in the rotating shaft 60 by way of rotating-shaft-front coolant reservoir portion 5.

### <Cooling Action>

Next, a flow of the coolant and a cooling action on respective structures by the coolant, at the time of operation of the electric rotating machine 100, will be described. When the coolant flows from the rotating-shaft-front coolant reservoir portion 5 to pass through the axial passage 61 and the radial passages 62, heat generated at the bearing 3 on the axial direction first side X1 is absorbed. A cooling oil as a coolant may be separately sent into the bearing 3 and the bearing 4 to thereby use the cooling oil commonly as a lubricant oil.

When the electric rotating machine 100 is driven, the rotor 40 rotates around the rotating shaft 60. The coolant supplied from the axial passage 61 in the rotating shaft 60 is subjected to centrifugal action in the radial passages 62, to thereby flow out into the first reservoir portion 14 constituted between the end plate 10 and the rotor-core end portion 41a.

The coolant reserved in the first reservoir portion 14 flows out into the second reservoir portion 15 through the gaps of the orifices 13 formed between the shield walls 12. The coolant reserved in the second reservoir portion 15 flows into the cooling passages 44 of the rotor core 41. The coolant passing through the cooling passages 44 cools the permanent magnets 43 by heat exchange, and is then discharged from end openings of the cooling passages 44 on the axial direction second side X2, while passing through the coolant outlets 45. Because of the rotation of the rotor 40, the discharged coolant is scattered radially outwardly and poured onto the coil end of the stator winding 52 to thereby cool the stator winding 52.

### <Numbers of Respective Passages and Effects by Reservoir Portions>

Next, description will be made on relationships among the number of the radial passages 62 formed in the rotor shaft 60, the number of the orifices 13 between the first reservoir portion 14 and the second reservoir portion 15 constituted between the end plate 10 and the rotor-core end portion 41a, and the number of the cooling passages 44 each as a part of the magnet storage hole 42 created in the rotor core 41 per each of the magnetic poles. Further, effects by the provision of the shield walls 12 that constitute the orifices 13, the first reservoir portion 14 and the second reservoir portion 15, will be described.

As the 13 orifices between the first reservoir portion 14 and the second reservoir portion 15, such orifices the number of which corresponds to the pole number of the rotor core 41 may be formed. The number of the orifices 13 may be set to be the same as the number of magnetic poles. If so set, the flow rate of the coolant to be supplied to the cooling passage 44 formed per each of the magnetic poles, can be regulated by each corresponding orifice 13, so that the supply amount of the coolant per each of the magnetic poles can be stabilized. Setting the number of the orifices 13 in this manner is effective in terms of cooling the respective permanent magnets 43 by uniformly supplying the coolant thereto.

Further, the number of the orifices 13 may be set to be the same as the number of the cooling passages 44 formed in the rotor core 41. The number of the orifices 13 may be an integral multiple of the number of the magnetic poles of the rotor core 41 or an aliquot part of the number of the magnetic poles. The number may be determined in consideration of balancing the stabilization of coolant distribution toward the cooling passages 44 formed for the respective magnetic poles of the rotor core 41, and the fabrication cost of the orifices 13. However, the fabrication cost and the processing accuracy-related load of the orifices 13 to be formed between the shield walls 12 are lower than the processing cost and the processing accuracy-related load of the radial passages 62 to be formed in the rotating shaft 60.

Meanwhile, the number of the radial passages 62 formed in the rotating shaft 60 may be a reduced number in comparison to the number of magnetic poles of the rotor core 41. This is because the coolant supplied from the radial passages 62 can then be supplied, after being once reserved in the first reservoir portion 14, uniformly to the cooling passages 44 formed for the respective magnetic poles, through the orifices 13. The number of the radial passages 62 may be one or two.

Accordingly, it becomes possible to decrease the number of the radial passages 62 in the rotating shaft 60 to thereby reduce the number of processing steps and thus to achieve cost reduction. Further, by decreasing the number of the radial passages 62 that are connected to the axial passage 61 in the rotating shaft 60 and radially penetrate therein, it is possible to decrease the number of open portions formed on the outer circumferential surface of the rotor shaft 60. Accordingly, it is expected that the strength and the reliability of the rotating shaft 60 will increase.

Furthermore, since the coolant supply toward the cooling passages 44 of the rotor core 41 is accomplished using the first reservoir portion 14, the orifices 13 and the second reservoir portion 15 that are constituted by the rotor-core end portion 41a and the end plate 10, it is possible to reduce the length of the axial passage 61 in the rotating shaft 60. This makes it possible to reduce the processing cost of the axial passage 61. At the same time, it is expected that the strength and the reliability of the rotating shaft 60 will increase.

In addition, since the supply amount of the coolant is regulated by the orifices 13, there is no need to precisely process the inner circle of the radial passage 62. The radial passage just has to ensure a cross-section area that allows supplying a prescribed amount or more of the coolant. Thus, it becomes also possible to further reduce the processing cost of the radial passages 62.

According to such a relatively simplified configuration in which the shield walls 12 are formed between the first reservoir portion 14 and the second reservoir portion 15, it becomes possible to divide a single space into two reservoir portions. The opening area of the orifice 13 can be adjusted according to a distance between the adjacent shield walls 12, so that it is easily achievable to set/change the opening area of the orifice.

By extending the shield walls 12 in a circumferential direction, the second reservoir portion 15 can be provided on the radially outer side of the first reservoir portion 14. Accordingly, when the rotor 40 rotates, a centrifugal force acts on the coolant in a direction from the first reservoir portion 14 to the second reservoir portion 15. As a result, the coolant is supplied into the orifices 13 through which the first reservoir portion 14 and the second reservoir portion 15 are connected to each other, and thus flows stably. This is effective in terms of supplying the coolant toward the cooling passages 44 uniformly in the circumferential direction.

### <Configuration Method of End Plate>

The end plate 10 is provided onto the end portion of the rotor core 41 on the axial direction first side X1. Note that the end plate 10 has functions of preventing the rotor core 41 from being detached from the rotating shaft 60, restricting the axial-direction position of the permanent magnets 43, and preventing the permanent magnet 43 from being dropped out of the magnet storage hole 42.

Further, the end plate 10 can additionally have, as a single member, a function of forming the first reservoir portion 14, the second reservoir portion 15 and the orifices 13, together with the rotor-core end portion 41a. For a rimmed dish-shaped end plate 10 having the outer peripheral wall 11, it is possible to additionally have such a function by forming therein the shield walls 12 as integral members.

The method of forming the shield walls 12 in the end plate 10 may be selected arbitrarily. The shield walls 12 may be formed in such a manner that plate-like members that form these walls are joined by welding, adhesion, screw fastening or the like, onto the surface of the end plate 10 facing to the rotor-core end portion 41a. Further, they may be formed by processing in such a manner that, in a thick plate member, recessed portions to be provided as the first reservoir portion 14 and the second reservoir portion 15 are engraved by cutting processing or the like while instead leaving portions to be provided as the shield walls 12, as convex portions.

Furthermore, it is possible to improve the productivity by forming the end plate 10 using a casting material, namely, fabricating the end plate 10 integrally with the shield walls 12. The end plate 10 can be fabricated with the shield walls 12 and even with the first reservoir portion 14 and the second reservoir portion 15, by using a common casting mold. This makes it possible to stably fabricate the end plate having an intended shape with less dimensional tolerances.

As the electric rotating machine 100 according to Embodiment 1, such an example has been described in which flow paths connecting from the radial passages 62 in the rotating shaft 60 to the cooling passages 44 in the rotor core 41 are established by the end plate 10 and the rotor-core end portion 41a. Since the flow paths are established by the end plate 10 and the rotor-core end portion 41a, an effect is produced that is advantageous in comparison with the case where the flow paths are ensured between the stacked steel plates that constitute the rotor core 41.

When radially outward flow paths are ensured between the stacked steel plates and in parallel to the flat surface of the steel plate, a problem arises in that the coolant may intrude into a gap between the steel plates, the coolant may be leaked out, and the gap between the steel plates may be enlarged due to pressure of the coolant. However, when the first reservoir portion 14, the second reservoir portion 15 and the orifices 13 are constituted by the end plate 10 and the rotor-core end portion 41a, it is possible to avoid the coolant from intruding into the gap between the steel plates, to avoid the coolant from being leaked out, and to avoid the gap from being enlarged due to pressure of the coolant.

Meanwhile, the shield walls 12 may be formed not on the side of the end plate 10 but on the side of the rotor-core end portion 41a. Specifically, out of the stacked steel plates that constitute the rotor core 41, some stacked steel plates placed near the rotor-core end portion 41a is processed to form the first reservoir portion 14 and the second reservoir portion 15. Namely, additional processing is applied that creates openings at the places of the stacked steel plates corresponding to the first reservoir portion 14, the second reservoir portion 15 and the orifices 13. And, no additional processing is applied to the other part of the stacked steel plates.

In that manner, the shield walls 12, the first reservoir portion 14, the second reservoir portion 15 and the orifices 13 may be formed on the side of the rotor core 41. According to such a configuration, it suffices to modify the punched-out shape of stacked steel plates, so that the end plate 10 may only have a plate-like circular shape with a hole. This produces an advantage that it is no longer need to form complicated shape on the side of end plate 10, to thereby reduce the number of the steps.

Furthermore, it is allowed that a recessed portion for constituting the first reservoir portion 14 and the second reservoir portion 15 is formed in the end plate 10 while the stacked steel plate of the rotor-core end portion 41a is subjected to cutting and raising processing toward the recessed portion of the end plate a 10. This makes it possible to achieve such configuration in which only the shield walls 12 are formed on the side of the rotor-core end portion 41a. Further, the shield walls 12 may be constituted in such a manner that plate-like members are joined to the rotor-core end portion 41a by welding, adhesion, screw fastening or the like.

<Cross-Section Area of Connection Portion where Radial Passage is Connected to First Reservoir Portion>

Here, a passage cross-section area of a connection portion where the radial passage 62 formed in the rotating shaft 60 and the first reservoir portion 14 constituted between the end plate 10 and the rotor-core end portion 41a are interconnected, will be discussed. The radial passages 62 shown in FIG. 2 and FIG. 4 each have a cylindrical flow path shape. This shape has been determined taking into account the workability and is also a desired shape in view of ensuring the strength of the rotating shaft 60 in which the radial passages 62 are formed.

The first reservoir portion 14 shown in FIG. 2 and FIG. 3 is a space interposed between two circular shapes of the end plate 10 and the rotor-core end portion 41a and in parallel thereto. As shown in FIG. 2, at the connection portion where the radial passage 62 and the first reservoir portion 14 are interconnected, the circular cross section of the radial passage 62 is partially covered by one or both of an end-plate radially inner-side surface 16 of the end plate 10 and a rotor-core-end-portion radially inner-side surface 46.

Accordingly, the passage cross-section area of the connection portion where the radial passage 62 and the first reservoir portion 14 are interconnected is determined in such a way that the circular cross section of the radial passage 62 is partially covered by the end-plate radially inner-side surface 16. Instead, the passage cross-section area of the connection portion is determined in such a way that the circular cross section of the radial passage 62 is partially covered by the rotor-core-end-portion radially inner-side surface 46. Further instead, the passage cross-section area of the connection portion is determined in such a way that the circular cross section of the radial passage 62 is partially covered both by the end-plate radially inner-side surface 16 and the rotor-core-end-portion radially inner-side surface 46.

This passage cross-section area of the connection portion where the radial passage 62 and the first reservoir portion 14 are interconnected, that was determined in such a way that the circular cross section of the radial passage 62 is covered partially, is defined as “S4”. Let's consider its relationship to the cross-section area S3 of the orifice 13. If the respective sums of passage cross-section areas are represented by “ΣS3” and “ΣS4”, the following relationship is preferable.

$$Σ S 3 < Σ S 4$$

Focusing on the case described in FIG. 1 to FIG. 4, there are provided four connection portions where the radial passages 62 and the first reservoir portion 14 are interconnected, and eight orifices 13. Thus, the following relationship is preferable.

$$( S 3 \times 8 ) < ( S 4 \times 4 )$$

With respect to the coolant passages, it is preferable that the sum of cross-section areas of the passages be reduced as the flow goes downstream. This makes it possible to stabilize the coolant flow rate in the cooling passage 44 on the most downstream side.

It is useful to design the passage cross-section area S4 of the connection portion where the radial passage 62 and the first reservoir portion 14 are interconnected, to be determined in such a way that the circular cross section of the radial passage 62 is covered partially. In cases where many varieties of the electric rotating machine 100 are to be produced with changes in the volume and outer shape, it is necessary to determine various radial passages 62 that are adequate according to required coolant flow rates. In principle, it is necessary to process the radial passage 62 so that the inner diameter thereof is changed according to the required coolant flow rate. In the processing of forming the radial passage 62 in the rotating shaft 60, when the inner diameter has to be changed, the number of processing steps increases and the component management is also complicated, resulting in an increase in cost.

In contrast, when the radial passage 62 with a large diameter is formed in the rotating shaft 60 and this configuration is standardized, it is possible to achieve fabrication cost reduction of the rotating shaft 60 provided with the radial passage 62. Further, the passage cross-section area S4 of the connection portion where the radial passage 62 and the first reservoir portion 14 are interconnected, is designed to be determined in such a way that the circular cross section of the radial passage 62 is covered partially. This makes it possible to adjust the flow rate of the coolant supplied from the radial passage 62, by modifying the end-plate radially inner-side surface 16 or the rotor-core-end-portion radially inner-side surface 46 that partially covers the circular cross section of the radial passage 62. An amount of the circular cross section of the radial passage 62 covered by the end-plate radially inner-side surface 16 and/or the rotor-core-end-portion radially inner-side surface 46 is determined basically by the material thickness of the circular plate-like shape. Thus, it is easy to process/modify such a component, and this contributes to production cost reduction. Further, since the passage cross-section area S4 can be changed merely by changing the thickness of the circular plate, the flexibility in design is also increased.

In the foregoing description of Embodiment 1, a case has been described where the first reservoir portion 14 is provided on the radially inner side of the second reservoir portion 15. However, the first reservoir portion 14 and the second reservoir portion 15 may be provided so that they are arranged in parallel along a radial direction, in such a manner that a partition is formed in a circumferentially continuous space. As an arrangement in which the second reservoir portion 15 is circumferentially adjacent to the first reservoir portion 14, such an arrangement may be adopted in which, between these reservoir portions, orifices 13 directed in the circumferential direction are formed so that these reservoir portions are mutually communicated.

### 2. Embodiment 2

### <Second Reservoir Portion Partition Walls>

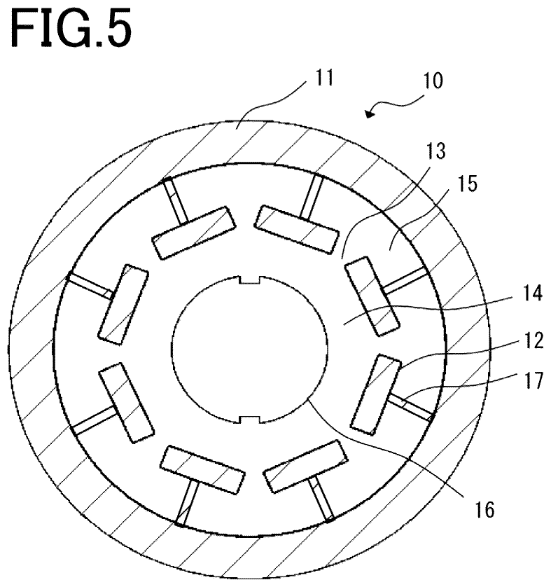

FIG. 5 is a sectional view showing coolant passages formed in an end plate 10 of an electric rotating machine 100 according to Embodiment 2. What differs from the coolant passages in the end plate 10 shown in FIG. 3 according to Embodiment 1 is in that second reservoir portion partition walls 17 by which the second reservoir portion 15 is partitioned per each of the orifices 13 are formed in the end plate 10. Since the second reservoir portion partition walls 17 are formed, the coolant whose flow rate has been adjusted by the orifices 13, can be distributed adequately to the cooling passages 44 that are provided correspondingly to the number of the magnetic poles.

If so configured, even if the coolant flows out due to breakage of a specific one of the cooling passages 44, the cooling passages 44 corresponding to the other magnetic poles are kept unaffected. This is because the second reservoir portion 15 partitioned per each of the orifices 13 can divisionally and separately supply adequate amounts of the coolant.

Further, such a configuration may also be adopted in which the first reservoir portion 14, not the second reservoir portion 15, is divided into plural portions. Furthermore, such a configuration may also be adopted in which the first reservoir portion 14 and the second reservoir portion 15 are both divided into their respective plural portions. When the first reservoir portion 14 is divided into plural portions, the number of that portions may be in a range having a maximum value that is equal to the number of the radial passages 62 formed in the rotating shaft 60. When the second reservoir portion 15 is divided into plural portions, the number of that portions may be in a range having a maximum value that is equal to the number of the cooling passages 44.

In this application, a variety of exemplary embodiments and examples are described; however, every characteristic, configuration or function that is described in one or more embodiments, is not limited to being applied to a specific embodiment, and may be applied alone or in any of various combinations thereof to another embodiment. Accordingly, an infinite number of modified examples that are not exemplified here are supposed within the technical scope disclosed in the present description. For example, such cases shall be included where at least one configuration element is modified; where at least one configuration element is added or omitted; and furthermore, where at least one configuration element is extracted and combined with a configuration element of another embodiment.

### DESCRIPTION OF REFERENCE NUMERALS AND SIGNS

10: end plate, 12: shield wall, 13: orifice, 14: first reservoir portion, 15: second reservoir portion, 16: end-plate radially inner-side surface, 17: second reservoir portion partition wall, 40: rotor, 41: rotor core, 41a: rotor-core end portion, 42: magnet storage hole, 43: permanent magnet, 44: cooling passage, 46: rotor-core-end-portion radially inner-side surface, 50: stator, 60: rotating shaft, 61: axial passage, 62: radial passage, 100: electric rotating machine.

1.-14. (canceled)

15. An electric rotating machine, comprising:
a rotor and a stator disposed around an outer circumference of the rotor,
said rotor being provided with:
a rotating shaft having an axial passage and at least one radial passage connected to the axial passage;
a rotor core fixed to the rotating shaft and having permanent magnets and axial cooling passages for cooling the permanent magnets; and
an end plate that is fixed to one axial end of the rotor core and that constitutes, together with said end of the rotor core, a first reservoir portion connected to said at least one radial passage of the rotating shaft, a second reservoir portion connected to said cooling passages of the rotor core, and orifices that connect together the first reservoir portion and the second reservoir portion,
wherein a number of the orifices that the rotor has, corresponds to a pole number of the rotor; and
wherein a number of said at least one radial passage that the rotating shaft has, is smaller than the number of the orifices.

16. The electric rotating machine as set forth in claim 15, wherein, in the rotor, the cooling passages of the rotor core are each a part of a magnet storage hole for fixing the permanent magnet.

17. The electric rotating machine as set forth in claim 15, wherein a number of the cooling passages that the rotor has, corresponds to a pole number of the rotor.

18. The electric rotating machine as set forth in claim 15, wherein, in the rotor, the second reservoir portion is provided on a radially outer side of the first reservoir portion.

19. The electric rotating machine as set forth in claim 15, wherein, in the rotor, a sum of respective cross-section areas of the orifices is smaller than a sum of respective cross-section areas of connection portions where said at least one radial passage is connected to the first reservoir portion.

20. The electric rotating machine as set forth in claim 19, wherein, in the rotor, the cross-section area of a connection portion where said at least one radial passage is connected to the first reservoir portion, is determined in such a way that a circular cross section of the radial passage is partially covered by a radially inner-side surface of the end plate.

21. The electric rotating machine as set forth in claim 19, wherein, in the rotor, the cross-section area of the connection portion where said at least one radial passage is connected to the first reservoir portion, is determined in such a way that a circular cross section of the radial passage is partially covered by a radially inner-side surface of an end portion of the rotor core.

22. The electric rotating machine as set forth in claim 15, wherein, in the rotor, the second reservoir portion is partitioned per each of the orifices.

23. The electric rotating machine as set forth in claim 15, wherein the rotor is provided with the end plate that uses a casting material.

24. An electric rotating machine, comprising:
a rotor and a stator disposed around an outer circumference of the rotor,
said rotor being provided with:
a rotating shaft having an axial passage and at least one radial passage connected to the axial passage;
a rotor core fixed to the rotating shaft and having permanent magnets and axial cooling passages for cooling the permanent magnets; and
an end plate that is fixed to one axial end of the rotor core and that constitutes, together with said end of the rotor core, a first reservoir portion connected to said at least one radial passage of the rotating shaft, a second reservoir portion connected to said cooling passages of the rotor core, and orifices that connect together the first reservoir portion and the second reservoir portion,
wherein the rotor includes a plurality of shield walls that separate the first reservoir portion and the second reservoir portion from each other, and the orifices are formed as gaps between the shield walls.

25. The electric rotating machine as set forth in claim 24, wherein, in the rotor, the shield walls extend in a circumferential direction of that rotor.

26. The electric rotating machine as set forth in claim 24, wherein, in the rotor, the first reservoir portion and the second reservoir portion are each formed as an interspace between an end portion of the rotor core and the end plate, and the shield walls are formed on the end plate.

27. The electric rotating machine as set forth in claim 24, wherein, in the rotor, the first reservoir portion and the second reservoir portion are each formed as an interspace between an end portion of the rotor core and the end plate, and the shield walls are formed on an end portion of the rotor core.

28. The electric rotating machine as set forth in claim 24, wherein, in the rotor, the second reservoir portion is partitioned per each of the orifices.

29. The electric rotating machine as set forth in claim 24, wherein the rotor is provided with the end plate that uses a casting material.
